(19) United States
(12) Patent Application Publication
(10) Pub. No.: US 2008/0291694 A1
(43) Pub. Date: Nov. 27, 2008

(54) PLANAR LIGHT SOURCE DEVICE AND DISPLAY DEVICE

(75) Inventors: Seiji SAKAI, Tokyo (JP); Akihiro Mori, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/117,889

(22) Filed: May 9, 2008

(30) Foreign Application Priority Data
May 25, 2007 (JP) 2007-138832

(51) Int. Cl. F21V 7/04; F21V 7/00

(52) U.S. Cl. 362/616; 362/311

(57) ABSTRACT

The present invention is aimed to obtain a highly reliable planar light source device even when an ambient temperature is high, without lowering brightness of the planar light source device. A planar light source device of the present invention includes a light source (point light source), a first light guide plate having an incident surface and an emitting surface for emitting planar light, and a second light guide plate having an incident surface opposing to the light source (point light source) and an emitting surface opposing to the incident surface of the first light guide plate, wherein a distance from the incident surface to the emitting surface opposite to each other of the second light guide plate (light guide distance) is not less than 1.5 mm.

### BACKGROUND OF THE INVENTION

1. Field of the Invention

The present invention relates to a planar light source device and a display device using the same, and especially to measures against heat generation of the light source.

2. Description of the Background Art

A planar light source device for irradiating a back surface of a liquid crystal panel with light to illuminate a display screen from a rear surface thereof includes a side light type and a direct type. In the planar light source device of the side light type (also referred to as an edge light type), the light source is disposed on a side surface of a case, and in the planar light source device of the direct type, the light source is disposed on a back surface of the case so as to be opposed to the liquid crystal panel. Further, the side light type planar light source device includes the one using a light guide plate for guiding the light from the light source to an opening of the case. The planar light source device using the light guide plate takes out the planar light from the opening by allowing the light emitted from a side light section formed of a linear light source such as a Cold Cathode Fluorescent Lamp (CCFL) or of a point light source such as a Light Emitting Diode (LED) to reflect within the light guide plate, and to diffuse by a diffusion pattern provided in the light guide pattern.

In general, in the planar light source device using the point light source such as the LED as a light emitting device, if higher brightness of the display screen is wanted, a density of the devices may be increased by multiplying the number of light emitting devices, or electric current to be supplied to each of the point light sources may be increased. However, in either case, a temperature of a surrounding portion of the point light source becomes high due to heat generated by each of the point light sources with emission of the light.

Therefore, the planar light source device in which heat radiating means is disposed on a substrate to which the point light source is attached has been suggested (refer to Japanese Patent Application Laid-Open No. 2002-229022 and Japanese Patent Application Laid-Open No. 2003-762872, for example). Since heat radiation may be improved with the planar light source, it becomes possible to increase the density of the devices of the point light source and the electrical current to be supplied to each of the point light sources.

### SUMMARY OF THE INVENTION

However, even with such conventional planar light source device, if the ambient temperature is especially high, a junction temperature of the LED increases and a surface temperature of the LED increases accordingly. Especially, in a case of acrylic in which a glass transition temperature of the light guide plate for guiding the light from the light source to the emitting surface is relatively low, a temperature of a light entering portion in the vicinity of the LED exceeds the glass transition temperature and then the light entering portion changes a shape thereof when the temperature of the surrounding portion is high, so that a path of the light guide plate in the vicinity of the LED of the emitting surface is disturbed and a defective indication such as a hot spot might occur. Also, if a clearance between the light source and the light guide plate is made larger, an incident efficiency of the light lowers, so that the brightness at the time of emission from the light guide plate lowers. As a countermeasure thereof, polycarbonate or the like of which glass transition temperature is high is used, for example, as a material of the light guide plate. However, since a light transmission of a long pathlength of polycarbonate is lower than that of acrylic, there is a problem that the brightness of the emitting surface of the light guide plate lowers by 10% to 20% especially when using a middle-sized or large-sized light guide plate.

An objection is to obtain a highly reliable planar light source device even when an ambient temperature is high, without lowering brightness of a planar light source device.

A planar light source device includes a light source, a first light guide plate and a second light guide plate.

The first light guide plate has an incident surface and an emitting surface for emitting planar light.

The second light guide plate has an incident surface opposing to the light source and an emitting surface opposing to the incident surface of the first light guide plate.

A distance from the incident surface to the emitting surface opposing to each other of the second light guide plate is not less than 1.5 mm.

The highly reliable planar light source device may be obtained even when the ambient temperature is high, without lowering the brightness of the planar light source device.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view of a liquid crystal display device according to a first embodiment of the present invention;

FIG. 2 is a cross-sectional view of a back light according to the first embodiment of the present invention;

FIG. 3 is a view showing a relationship between a distance from a point light source to a second light guide plate and an incident efficiency, according to the first embodiment of the present invention; and

FIG. 4 is a view showing a relationship between a light guide distance of the second light guide plate and the highest temperature of the first light guide plate in a case of an ambient temperature of 85° C., according to the first embodiment of the present invention.

### DESCRIPTION OF THE PREFERRED EMBODIMENTS

Hereinafter, the present invention will be specifically described based on the drawings showing the embodiments thereof.

### First Embodiment

### (Configuration)

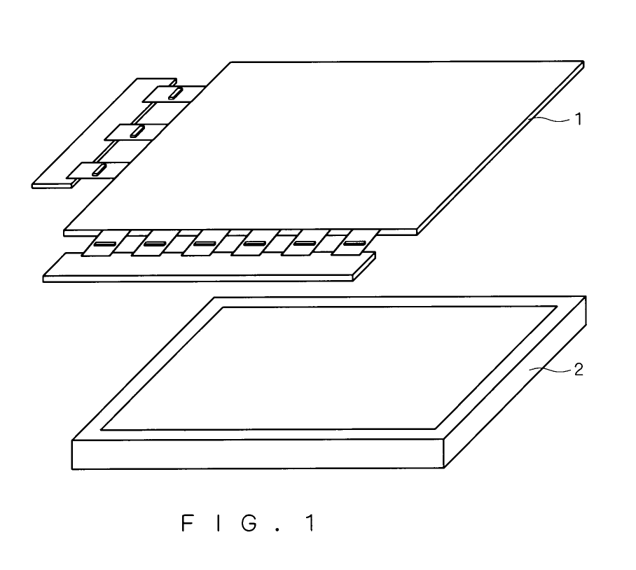

FIG. 1 is an exploded perspective view showing one example of a schematic configuration of a liquid crystal display device (display device) according to a first embodiment of the present invention, showing an appearance of the liquid crystal display device including a liquid crystal panel 1 for performing data writing to a pixel and a back light (planar light source device) 2 for illuminating the liquid crystal panel (display panel) 1 from a back surface side thereof in synchronization with a data writing operation. The liquid crystal display device according to this embodiment is a thin liquid crystal display of which frame region is made narrow.

The liquid crystal panel 1 is a transmission display device including a TFT (Thin Film Transistor) array substrate holding a liquid crystal between the liquid crystal panel 1 and an opposing substrate. A number of pixels are disposed in a matrix pattern on a display region formed on a panel surface. Herein, a shape of the display region should be a horizontally-long rectangle, and a gate line (also referred to as an address line) is formed so as to be parallel to a long side thereof and a source line (also referred to as a data line) is formed so as to be parallel to a short side thereof.

A plurality of gate line driving drivers for switching on and off the TFT as a semiconductor switching device provided for each pixel and a plurality of source line driving drivers for supplying image data to each pixel by means of the TFT are formed around the display region. The drivers are formed on the TFT array substrate as the semiconductor chip, for example, and the data writing to each pixel is performed by a controller controlling each driver. The data writing to each pixel is performed based on an image signal, and the image data is written to the pixel along the gate line, which is on-driven with a predetermined scanning period for each gate line.

The back light 2 is the planar light source device for emitting uniform light from an opening formed on a case thereof, and is disposed on a back surface side of the liquid crystal panel 1. A shape of the opening is made slightly larger than a shape of the display region. That is to say, this is shaped into a horizontally-long rectangle in which a side parallel to the gate line of the liquid crystal panel 1 is made a long side.

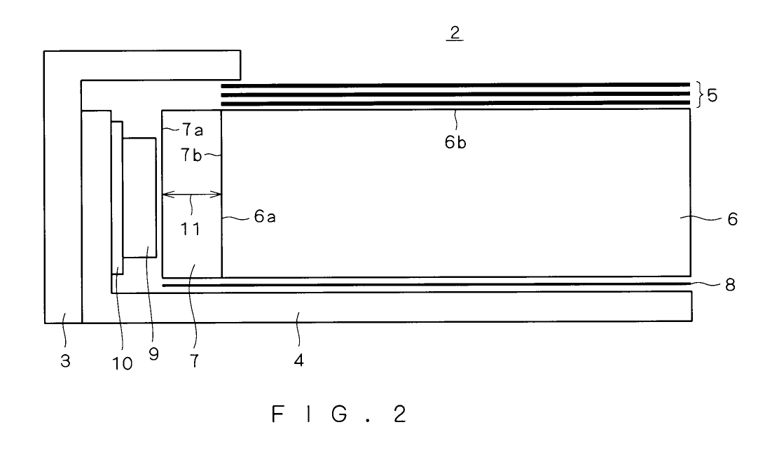

FIG. 2 is a cross-sectional view showing one example of a detail of a substantial part in the liquid crystal display device of FIG. 1, showing an appearance in the backlight 2.

The backlight 2 has an upper case 3 covering an end edge of a front surface (upper surface in FIG. 2) on which light of the backlight is illuminated and a side surface, and a lower case 4 covering a back surface (lower surface in FIG. 2) and the side surface. An opening, which is an emitting region of emitting light, is formed on a front surface of the upper case 3. In addition, a substrate 10 is provided on an inner side surface of the lower case 4, and a point light source 9 is provided on a surface of the substrate 10.

Further, the backlight 2 has a planar first light guide plate 6 made of acrylic having an incident surface 6a and an emitting surface 6b for emitting planar light and a second light guide plate 7 made of polycarbonate having an incident surface 7a opposing to the point light source 9 and an emitting surface 7b opposing to the incident surface 6a of the first light guide plate 6, within the upper and lower cases 3 and 4. Meanwhile, a light guide distance (distance from incident surface 7a to emitting surface 7b opposing to each other) 11 of the second light guide plate 7 is assured to be not less than 1.5 mm.

Optical sheets 5 such as a diffusion sheet and a prism sheet are provided on a front surface of the first light guide plate 6, and a reflecting sheet 8 is provided on a back surface of the first light guide plate 6.

The lower case 4 is a frame for accommodating and holding each of the above-described members, and is made of a synthetic resin and metal excellent in strength and workability. Especially, it is desirable that aluminum and copper excellent in heat conductivity is used from the viewpoint of radiation of heat generated by light emission of the point light source 9.

The optical sheets 5 are sheet-like optical members having translucency, such as the diffusion sheet for diffusing light and the prism sheet on which a prism row is formed. The diffusion sheet is formed by mixing a minute reflective material in a transparent member such as the synthetic resin and glass or by roughening a surface thereof. A plurality of kinds of the optical sheets 5 or a plurality of optical sheets 5 are used as needed in order to obtain desired brightness distribution and chromaticity distribution of the emitting light.

The second light guide plate 7 is an optical member for emitting light entered from each point light source 9 arranged along one end surface thereof from a surface opposing to the incident surface. The second light guide plate 7 is made of a planar member such as a translucent organic resin having a high glass transition temperature or glass because heat from the light source affects the same. In this embodiment, polycarbonate of which glass transition temperature is relatively high as 145° C. is used. The polycarbonate has the glass transition temperature higher than that of the acrylic used in the first light guide plate 6.

The first light guide plate 6 is an optical member for emitting light entered to an end surface thereof from the front surface thereof. A planar acrylic resin excellent in long pathlength transmission and having a low haze value even in a long pathlength is used as the first light guide plate 6, because it is required to transmit the light to a side opposite to the incident surface side. With the resin other than acrylic, especially polycarbonate, since the long pathlength transmission thereof is lower than that of acrylic and a long pathlength haze value is larger, incident light is absorbed by the resin while being guided, or is diffused while being guided and the light is emitted from the emitting surface 6b, so that it is difficult to maintain a uniform display quality because the brightness emitted from the emitting surface 6b is lower than that of the acrylic plate and the light hardly reaches the surface opposite to the incident surface, especially when a light path length is longer than 50 nm.

Meanwhile, a shape of the first light guide plate 6 is not limited to planar, and the light entered in the light guide plate may be emitted from the front surface side more efficiently with a wedge shape, for example.

In addition, a diffusion pattern is formed on the back surface of the first light guide plate 6. Specifically, a method for printing a dot pattern using white pigment containing titanium oxide, and a method for forming a circular, conical or rectangular micro pattern when shaping the light guide plate are possible. By adjusting the diffusion pattern, a desired brightness distribution in a direction perpendicular to an array direction of each point light source, that is to say, in a direction parallel to a long side of emitting region may be obtained. That is to say, concentration, shape, size, and depth of the diffusion pattern are determined such that the brightness distribution of emitting light is optimized.

The point light source 9 is a point light source capable of high-speed switching of a few ms or higher formed of light emitting device such as a LED (Light Emitting Diode), LD (Laser Diode) and EL (Electro Luminescence). Herein, a plurality of colors of LEDs each emitting a single color are combined and used. Meanwhile, each of the point light sources 9 is provided along a longitudinal direction of a rectangular point light source substrate 10, mounted together with a circuit pattern (not shown), and is connected to a driver for driving each of the point light sources 9.

For example, the LEDs of R (red), G (green) and B (blue) are used as the point light sources 9. By adjusting a light emitting volume by the LEDs of each color, a color tone of the emitting light may be easily changed. Also, it is possible to improve color reproductivity on a screen display of the liquid crystal panel 1 (FIG. 1).

As described above, the reflective sheet 8 for reflecting the light from the light guide plate to the front surface side is disposed on the back surface side of the first light guide plate 6. The reflective sheet 8 is a sheet-like optical member formed of a silver-evaporated flat plate or a white resin plate. In order to effectively emit light from each of the point light sources, it is preferable that a reflectivity of the reflective sheet 8 is no less than 90%.

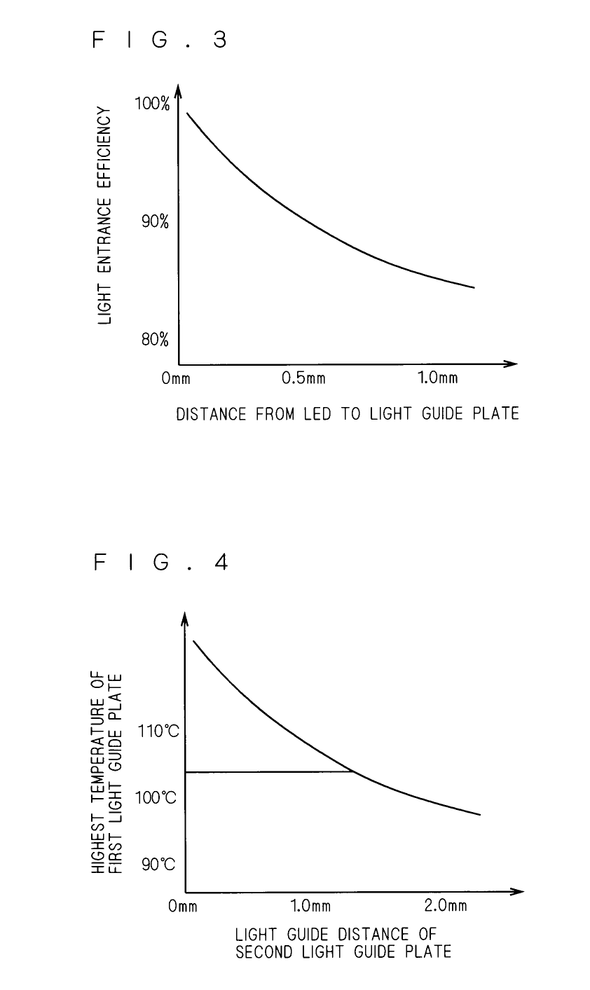

FIG. 3 shows a relationship between a distance from the light emitting surface of the LED, which is the point light source 9, to the incident surface 7a of the second light guide plate 7 and a percentage of light entering into the second light guide plate 7 out of the light emitted from the point light source 9 (light entrance efficiency). FIG. 3 shows that the closer the point light source 9 and the incident surface 7a of the second light guide plate 7 is, the higher a light use efficiency is. The light may enter the light guide plate in the most efficient manner, by allowing the point light source 9 and the incident surface 7a of the second light guide plate 7 to adhere to each other. In this embodiment, the emitting surface of the point light source 9 and the incident surface 7a of the second light guide plate 7 are adhered to each other to allow light to enter.

### (Method for Manufacturing)

In this embodiment, the emitting surface 7b of the second light guide plate 7 and the incident surface 6a of the first light guide plate 6 are bonded to each other by means of a visible light cure or ultraviolet cure translucent adhesive. Thereby, a surface reflection when emitting from the second light guide plate 7 to an air layer and a surface reflection when emitting from the air layer to the incident surface 6a of the first light guide plate 6 in a case where the air layer is interposed between the emitting surface 7b of the second light guide plate 7 and the incident surface 6a of the first light guide plate 6 may be reduced, so that it becomes possible to efficiently deliver the light between the light guide plates.

### (Operation)

Next, a light path in which the light emitted from the point light source 9 is transmitted through the second light guide plate 7 and the first light guide plate 6, and thereafter the resultant light is emitted from opening on the upper case 3 and enters the liquid crystal panel 1 will be described.

As shown in FIG. 2, the light emitted from the point light source 9 directly enters the incident surface 7a of the second light guide plate 7. The light entering the second light guide plate 7 is transmitted through the second light guide plate 7 while repeating total reflection due to a difference in refractive index between the second light guide plate 7 and the air. In the transmission process, the light is diffused and then the discretely arranged point light source 9 may be mixed.

The light emitted from the emitting surface 7b of the second light guide plate 7 directly enters the first light guiding plate 6 from the incident surface 6a. The light entering the first light guide plate 6 is transmitted through the first light guide plate 6, and in the transmission process, the transmission direction thereof is disturbed by the diffusion pattern provided on the surface opposite to the emitting surface, and this becomes the light emitted from the emitting surface 6b. Meanwhile, although a part of light is emitted from a surface other than the emitting surface 6b of the first light guide plate 6, the reflective sheet 8 is provided on the surface other than the incident surface 6a and the emitting surface 6b. The light emitted from the surface other than the emitting surface 6b and the incident surface 6a of the first light guide plate 6 is reflected by the reflective sheet 8 to be returned to the first light guide plate 6, and thereafter the resultant light is emitted from the emitting surface 6b. The light emitted from the emitting surface 6b enters the optical sheets 5 and is adjusted to an optional light distribution, and then enters the liquid crystal panel 1.

### (Effect)

FIG. 4 shows a relationship between a light guide distance of the second light guide plate 7 (distance from the incident surface 7a to the emitting surface 7b opposite to each other) 11 and the highest temperature of the first light guide plate 6 at an ambient temperature of 85° C. Since the first light guide plate 6 is made of acrylic, it is necessary that the temperature is lower than 105° C., which is the glass transition temperature of acrylic, so that it is required that the light guide distance 11 of the second light guide plate 7 is assured to be not less than about 1.5 mm. By assuring the distance to be not less than 1.5 mm, a temperature of the light entering surface of the first light guide plate 6 never exceeds the glass transition temperature. Therefore, it is possible to obtain the highly reliable planar light source device even when the ambient temperature is high, while using the light guide plate having high transparency.

Meanwhile, in the incident surface 7a of the second light guide plate 7, by providing a prism shape (not shown) on a corner perpendicular to the array direction of the point light source 9, the light of the point light source 9 may be diffused within the light guide plate, so that a display quality of the back light 2 may be improved.

### Second Embodiment

In this embodiment, the description other than a method of joining the emitting surface 7b of the second light guide plate 7 and the incident surface 6a of the first light guide plate 6 in FIG. 2 is the same as that of the first embodiment, so that a detailed description regarding the configuration and operation will be omitted.

### (Method for Manufacturing)

In this embodiment, first, the first light guide plate 6 is made by casting or machining a plate material. As a material of the first light guide plate 6, the acrylic resin is used as in the first embodiment. Next, the first light guide plate 6 is fit in a die to make the second light guide plate 7 on a light entering side on the first light guide plate 6 side by casting, and integrally shaping the incident surface 6a of the first light guide plate 6 and the emitting surface 7b of the second light guide plate 7.

### (Effect)

By the above-described method for manufacturing, the air layer between the first light guide plate 6 and the second light guide plate 7 is excluded, so that a transmission efficiency between the light guide plates is improved. Also, by integrally forming, a strength of a joining section is improved, thereby increasing a reliability.

While the invention has been shown and described in detail, the foregoing description is in all aspects illustrative and not restrictive. It is therefore understood that numerous modifications and variations can be devised without departing from the scope of the invention.

What is claimed is:

1. A planar light source device, comprising:
a light source;
a first light guide plate having an incident surface and an emitting surface for emitting planar light; and
a second light guide plate having an incident surface opposing to said light source and an emitting surface opposing to said incident surface of said first light guide plate, wherein
a distance from said incident surface to said emitting surface opposing to each other of said second light guide plate is not less than 1.5 mm.

2. The planar light source device according to claim 1, wherein said emitting surface of said second light guide plate and said incident surface of said first light guide plate are bonded to each other by means of a translucent adhesive.

3. The planar light source device according to claim 1, wherein said emitting surface of said second light guide plate and said incident surface of said first light guide plate are integrally shaped.

4. The planar light source device according to claim 1, wherein a glass transition temperature of said second light guide plate is higher than a glass transition temperature of said first light guide plate.

5. The planar light source device according to claim 1, wherein a material of said first light guide plate is acrylic.

6. The planar light source device according to claim 1, wherein a material of said second light guide plate is polycarbonate.

7. The planar light source device according to claim 1, wherein said light source includes an LED.

8. A display device, comprising:
a display panel; and
a planar light source device disposed on a back surface of said display panel, wherein
said planar light source device includes:
a light source;
a first light guide plate having an incident surface and an emitting surface for emitting planar light; and
a second light guide plate having an incident surface opposing to said light source and an emitting surface opposing to said incident surface of said first light guide plate, wherein
a distance from said incident surface to said emitting surface opposing to each other of said second light guide plate is not less than 1.5 mm.

9. The display device according to claim 8, wherein said emitting surface of said second light guide plate and said incident surface of said first light guide plate are bonded to each other by means of a translucent adhesive.

10. The display device according to claim 8, wherein said emitting surface of said second light guide plate and said incident surface of said first light guide plate are integrally shaped.

11. The display device according to claim 8, wherein a glass transition temperature of said second light guide plate is higher than a glass transition temperature of said first light guide plate.

12. The display device according to claim 8, wherein a material of said first light guide plate is acrylic.

13. The display device according to claim 8, wherein a material of said second light guide plate is polycarbonate.

14. The display device according to claim 8, wherein said light source includes an LED.
